(19) United States
(12) Patent Application Publication
(10) Pub. No.: US 2023/0194096 A1
(43) Pub. Date: Jun. 22, 2023

(54) EXHAUST SYSTEM FOR A GAS TURBINE ENGINE AND METHOD FOR USING SAME

(71) Applicant: Pratt & Whitney Canada Corp., Longueuil (CA)

(72) Inventor: Russell Stratton, Toronto (CA)

(21) Appl. No.: 17/554,844

(22) Filed: Dec. 17, 2021

(51) Int. Cl. F23R 3/40; F02C 3/30

(52) U.S. Cl. CPC F23R 3/40; F02C 3/30; F05D 2220/323; F05D 2240/128; F05D 2260/60

(57) ABSTRACT

A gas turbine engine for an aircraft includes a turbine section and an exhaust section configured to receive an exhaust gas stream from the turbine section. The exhaust section includes a monolithic catalyst structure configured to remove nitrogen oxides (NOₓ) from the exhaust gas stream.

### TECHNICAL FIELD

This disclosure relates generally to exhaust systems for aircraft gas turbine engines and more particularly to exhaust systems configured for treating combustion exhaust gases of aircraft gas turbine engines.

### BACKGROUND OF THE ART

It is generally known in the art to power aircraft gas turbine engines with gases expelled from combustion chambers. In the gas turbine engine, a fuel is combusted in an oxygen rich environment. The fuel may be any appropriate fuel such as a liquid or gas. Exemplary fuels include hydrocarbons (for example methane or kerosene) or hydrogen. Generally, these combustion systems may emit undesirable compounds such as nitrous oxide compounds (NOₓ) and carbon containing compounds. It is generally desirable to decrease various emissions as much as possible so that selected compounds may not enter the atmosphere. In particular, it has become desirable to reduce NOₓ, emissions to a substantially low amount. There is a need in the art, therefore, for improved systems and methods for reducing NOₓ, emissions from aircraft gas turbine engines.

### SUMMARY

It should be understood that any or all of the features or embodiments described herein can be used or combined in any combination with each and every other feature or embodiment described herein unless expressly noted otherwise.

According to an aspect of the present disclosure, a gas turbine engine for an aircraft includes a turbine section and an exhaust section configured to receive an exhaust gas stream from the turbine section. The exhaust section includes a monolithic catalyst structure.

In any of the aspects or embodiments described above and herein, the gas turbine engine further includes a fixed structure surrounding at least a portion of the turbine section. The exhaust section further includes a diffuser nozzle mounted to the fixed structure downstream of the turbine section and configured to receive the exhaust gas stream from the turbine section. The monolithic catalyst structure is located within the diffuser nozzle.

In any of the aspects or embodiments described above and herein, the gas turbine engine may be a turboprop or a turboshaft gas turbine engine.

In any of the aspects or embodiments described above and herein, the monolithic catalyst structure may include a plurality of cells defining a respective plurality of channels extending therethrough.

In any of the aspects or embodiments described above and herein, the plurality of cells may include a catalytic washcoat.

In any of the aspects or embodiments described above and herein, the turbine section may include a reducing agent injection system configured to inject a reducing agent into a core flow path of the gas turbine engine.

In any of the aspects or embodiments described above and herein, the reducing agent injection system may be located upstream of the turbine section.

In any of the aspects or embodiments described above and herein, the reducing agent injection system may be located downstream of the turbine section.

In any of the aspects or embodiments described above and herein, the reducing agent may be an ammonia-based reducing agent.

In any of the aspects or embodiments described above and herein, the gas turbine engine further may include a nacelle defining an exterior housing of the gas turbine engine. The diffuser nozzle may be entirely located within the nacelle.

In any of the aspects or embodiments described above and herein, the monolithic catalyst structure may be located in a first axial portion of the housing. A first diameter of the housing in the first axial portion may be greater than a second diameter of a nozzle inlet of the diffuser nozzle and a third diameter of a nozzle outlet of the diffuser nozzle.

According to another aspect of the present disclosure, a method for treating exhaust gases from a gas turbine engine for an aircraft is provided. The method includes directing an exhaust gas stream from a turbine section of the gas turbine engine into an exhaust section of the gas turbine engine and directing the exhaust gas stream through a monolithic catalyst structure of the exhaust section to remove nitrogen oxides (NOₓ) from the exhaust gas stream.

In any of the aspects or embodiments described above and herein, the exhaust section may further include a diffuser nozzle configured to receive the exhaust gas stream from the turbine section and the monolithic catalyst structure may be located within the diffuser nozzle.

In any of the aspects or embodiments described above and herein, the monolithic catalyst structure may include a plurality of cells defining a respective plurality of channels extending therethrough.

In any of the aspects or embodiments described above and herein, the method may further include injecting a reducing agent into a core flow path of the gas turbine engine.

In any of the aspects or embodiments described above and herein, the step of injecting the reducing agent into the core flow path of the gas turbine engine may include injecting the reducing agent into the core flow path upstream of the turbine section.

In any of the aspects or embodiments described above and herein, the step of injecting the reducing agent into the core flow path of the gas turbine engine may include injecting the reducing agent into the core flow path downstream of the turbine section.

In any of the aspects or embodiments described above and herein, the step of injecting the reducing agent into the core flow path of the gas turbine engine may include injecting an ammonia-based reducing agent into the core flow path of the gas turbine engine.

In any of the aspects or embodiments described above and herein, the diffuser nozzle may be located entirely within a nacelle defining an exterior housing of the gas turbine engine.

In any of the aspects or embodiments described above and herein, the method may further include diffusing exhaust gas stream with the diffuser nozzle at a first axial location within the diffuser nozzle and subsequently concentrating the exhaust gas stream with the diffuser nozzle at a second axial location within the diffuser nozzle which is different than the first axial location.

The present disclosure, and all its aspects, embodiments and advantages associated therewith will become more readily apparent in view of the detailed description provided below, including the accompanying drawings.

### DESCRIPTION OF THE DRAWINGS

FIG. 1 illustrates a side schematic view of a gas turbine engine including a diffuser nozzle, in accordance with one or more embodiments of the present disclosure.

FIG. 2 illustrates a side view of a diffuser nozzle for a gas turbine engine, in accordance with one or more embodiments of the present disclosure.

FIG. 3 illustrates a cross-sectional view of the diffuser nozzle of FIG. 2, in accordance with one or more embodiments of the present disclosure.

FIG. 4 illustrates a portion of the gas turbine engine of FIG. 1 including a reducing agent injection system, in accordance with one or more embodiments of the present disclosure.

FIG. 5 illustrates a portion of the gas turbine engine of FIG. 1 including a reducing agent injection system, in accordance with one or more embodiments of the present disclosure.

### DETAILED DESCRIPTION

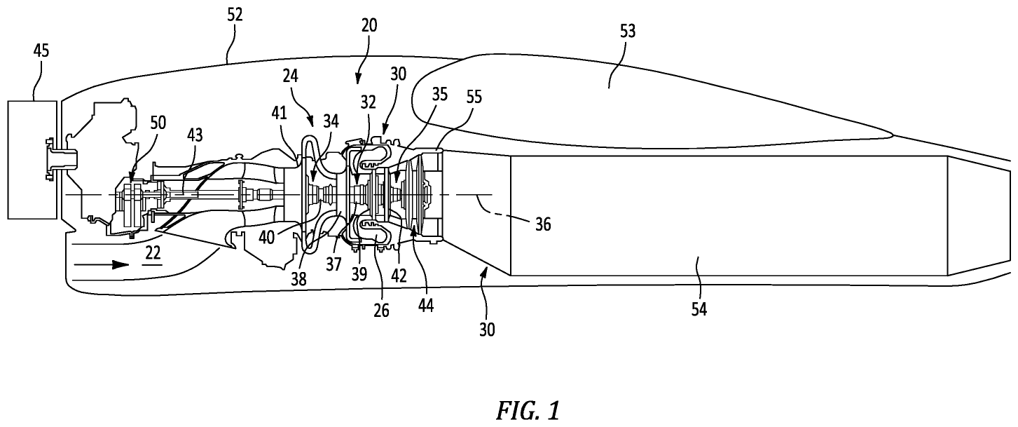

FIG. 1 illustrates a gas turbine engine 20 of a type preferably provided for use in subsonic flight, generally comprising in serial flow communication along a core flow path 21 through an air inlet 22, a compressor section 24 for pressurizing the air from the air inlet 22, a combustor 26 in which the compressed air is mixed with fuel and ignited for generating an annular stream of hot combustion gases, a turbine section 28 for extracting energy from the combustion gases, and an exhaust section 30 through which the combustion exhaust gases exit the gas turbine engine 20.

The gas turbine engine 20 of FIG. 1 generally includes a high-pressure spool 32, a low-pressure spool 34, and a power spool 35 mounted for rotation about an axial centerline 36 (e.g., a rotational axis) of the gas turbine engine 20. The high-pressure spool 32 generally includes a high-pressure shaft 37 that interconnects a high-pressure compressor 38 and a high-pressure turbine 39. The low-pressure spool 34 generally includes a low-pressure shaft 40 that interconnects a low-pressure compressor 41 and a low-pressure turbine 42. The power spool 35 generally includes a drive output shaft 43 in rotational communication with a power turbine 44 having a forward end configured to drive a rotatable load 45. The rotatable load 45 can, for instance, take the form of a propeller. In alternative embodiments, the gas turbine engine 20 may be configured such that the rotatable load 45 may include a rotor, such as a helicopter main rotor, driven by the drive output shaft 43. The drive output shaft 43 may be connected to the rotatable load 45 through a gear assembly 50 to drive the rotatable load 45 at a lower speed than the power spool 35. It should be understood that “low pressure” and “high pressure,” or variations thereof, as used herein, are relative terms indicating that the high pressure is greater than the low pressure. The high-pressure shaft 37, the low-pressure shaft 40, and the drive output shaft 43 may be concentric about the axial centerline 36. The gas turbine engine 20 of FIG. 1 further includes a nacelle 52 defining an exterior housing of the gas turbine engine 20. The gas turbine engine 20 of FIG. 1 further includes an aircraft wing 53 mounted to and extending outward from the nacelle 52.

The gas turbine engine 20 of FIG. 1 may be configured, for example, as a turboprop or a turboshaft gas turbine engine. It should be understood that the concepts described herein are not limited to use with turboprops as the teachings may be applied to other types of gas turbine engines such as turbofan gas turbine engines as well as those gas turbine engines including single-spool or two-spool architectures.

In some embodiments, the gas turbine engine 20 may include a diffuser nozzle 54 in the exhaust section 30 of the gas turbine engine 20. The diffuser nozzle 54 is configured to direct combustion exhaust gases and to decelerate the combustion exhaust gases for post-combustion treatment to reduce or otherwise mitigate the emission of air pollutants from the gas turbine engine 20 including, but not limited to, nitrogen oxides (NOₓ). The gas turbine engine 20 may include a fixed structure 55 such as a casing or cowl surrounding at least a portion of the turbine section 28. The diffuser nozzle 54 may be mounted to the fixed structure 55 axially downstream of the turbine section 28. As shown in FIG. 1, at least a portion of the diffuser nozzle 54 may be located within the nacelle 52 surrounding the gas turbine engine 20. In some embodiments, the diffuser nozzle 54 may be entirely disposed within the nacelle 52. Aspects of the present disclosure diffuser nozzle 54 maybe particularly relevant in for the treatment of combustion exhaust gases turboprop or turboshaft gas turbine engines, as the combustion exhaust gases may not be used to generate a substantial amount of thrust for an associated aircraft. Accordingly, treatment of the combustion exhaust gases to remove NOₓ, may provide a valuable means of controlling emissions of air pollutants without restricting the operational capacity of the associated gas turbine engine. However, it should be understood that aspects of the present disclosure may also be relevant to other types of aircraft gas turbine engines such as turbofan and turbojet gas turbine engines.

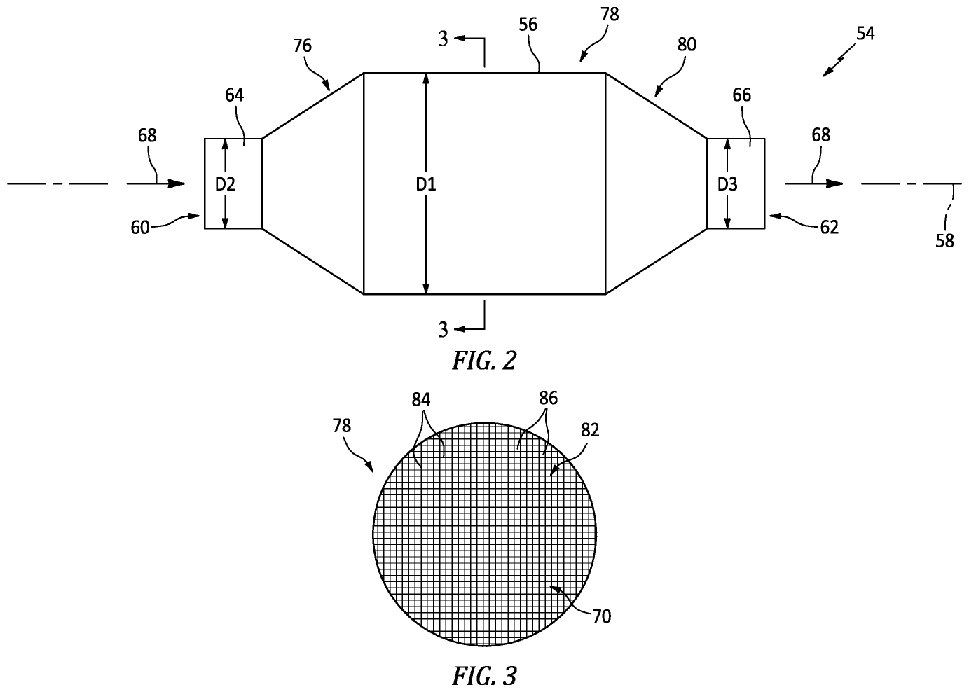

Referring to FIGS. 2 and 3, the diffuser nozzle 54 includes a housing 56 disposed about a nozzle axis 58 and extending between a first nozzle end 60 and a second nozzle end 62. The nozzle axis 58 may or may not be colinear with the axial centerline 36 of the gas turbine engine 20. The housing 56 includes a nozzle inlet 64 located at the first nozzle end 60 and a nozzle outlet 66 located at the second nozzle end 62. Combustion exhaust gases (schematically illustrated in FIG. 2 as exhaust gas stream 68) are directed from the turbine section 28 to the nozzle inlet 64 and then through the diffuser nozzle 54 in a direction from the nozzle inlet 64 to the nozzle outlet 66. The housing 56 radially surrounds and defines a nozzle duct 70 of the diffuser nozzle 54 extending from the nozzle inlet 64 to the nozzle outlet 66 and including the nozzle inlet 64 and the nozzle outlet 66.

In an upstream-to-downstream direction as shown in FIG. 2, the diffuser nozzle 54 may include the nozzle inlet 64, a diffusing axial portion 76, a treatment axial portion 78, a concentrating axial portion 80, and the nozzle outlet 66. The treatment axial portion 78 includes a maximum cross-sectional area of the nozzle duct 70. A diameter D1 of the housing 56 along the treatment axial portion 78 is greater than a diameter D2 of the housing 56 at the nozzle inlet 64 and a diameter D3 of the housing 56 at the nozzle outlet 66. Within the diffusing axial portion 76, the duct cross-sectional area of each duct section 74 gradually increases until reaching a maximum duct cross-sectional area within the treatment axial portion 78. Within the concentrating axial portion 78, the duct cross-sectional area of each duct section 74 gradually decreases from the maximum duct cross-sectional area of the treatment axial portion 78 until reaching the nozzle outlet 66.

The present disclosure exhaust section 30 of the gas turbine engine 20 includes a monolithic catalyst structure 82 configured to treat air pollutants such as NOₓ, from the exhaust gas stream 68 as the exhaust gas stream 68 passes through the monolithic catalyst structure 82. In some embodiments, the monolithic catalyst structure 82 may be part of and located within the diffuser nozzle 54, as shown in FIG. 3. For example, the monolithic catalyst structure 82 may be located within the treatment axial portion 78 of the diffuser nozzle 54. However, the present disclosure is not limited to the inclusion of the monolithic catalyst structure 82 in the diffuser nozzle 54 and the monolithic catalyst structure 82 may be included in the exhaust section 30 within the diffuser nozzle 54 of FIGS. 1-3. FIG. 3 illustrates a cross-sectional view of the treatment axial portion 78 of the diffuser nozzle 54 showing the monolithic catalyst structure 82. The monolithic catalyst structure 82 may be disposed across all or substantially all of the duct cross-sectional area within the treatment axial portion 78 of the nozzle duct 70.

The monolithic catalyst structure 82 may be made from a ceramic material forming a plurality of substrate cells 84. The plurality of substrate cells 84 define a respective plurality of channels 86 extending through the monolithic catalyst structure 82 in a generally axial direction. The monolithic catalyst structure 82 includes a catalyst washcoat applied to the surfaces of the substrate cells 84. The catalyst washcoat serves as a carrier for a catalyst such as, but not limited to, platinum, palladium, rhodium, and/or zeolite, which catalyst is used to stimulate and accelerate a NOₓ, reduction chemical reaction of the monolithic catalyst structure 82. As shown in FIG. 3, the substrate cells of the plurality of substrate cells 84 may have a generally square cross-sectional shape. However, plurality of substrate cells 84 can have other cross-sectional shapes such as hexagons, circles, etc. Density of the plurality of substrate cells 84 may vary widely depending on the particular application of the diffuser nozzle 54 as well as other considerations such as the acceptable pressure loss through the diffuser nozzle 54 and the emissions reduction requirements for the diffuser nozzle 54. Accordingly, the density of the plurality of substrate cells 84 may range from approximately 1 to 900 cells per square inch. The plurality of substrate cells 84 may have an average wall thickness in a range of approximately 0.002 to 0.040 inches (i.e., 2-40 mils). The catalyst washcoat applied to the plurality of substrate cells 84 may have an average thickness in a range of approximately 0.001 to 0.002 inches (i.e., 1-2 mils).

Combustion exhaust gases of the exhaust gas stream 68 passing through the diffuser nozzle 54 are directed through the monolithic catalyst structure 82 where the exhaust gas stream 68 is treated through chemically interaction with the catalyst washcoat applied to the surfaces of the plurality of substrate cells 84. Diffusion of the exhaust gas stream 68 within the diffusing axial portion 76 of the diffuser nozzle 54 from the nozzle inlet 64 to the maximum cross-sectional area provided by the treatment axial portion 78 provides for an increase in the static pressure of the exhaust gas stream 68 and a reduction in velocity of the exhaust gas stream 68, within the treatment axial portion 78 of the diffuser nozzle 54. By reducing the velocity of the exhaust gas stream 68 within the treatment axial portion 78, the length of time for chemical interaction between the exhaust gas stream 68 and the monolithic catalyst structure 82 may be increased, thereby improving post-combustion treatment of the exhaust gas stream 68. Moreover, the pressure losses of the exhaust gas stream 68 passing through the monolithic catalyst structure 82 are reduced. Concentration of the exhaust gas stream 68 within the concentrating axial portion 80 of the diffuser nozzle 54 from the treatment axial portion 78 to the nozzle outlet 66 provides for a decrease in the static pressure of the exhaust gas stream 68 and an increase in velocity of the exhaust gas stream 68 which exits the nozzle outlet 66 of the diffuser nozzle 54, thereby providing some amount of usable thrust. Accordingly, the configuration of the diffuser nozzle 54 may provide a tradeoff whereby an axial length of the diffuser nozzle 54 may be decreased while a diameter of the diffuser nozzle 54 (e.g., the diameter D1 of the housing 56 along the treatment axial portion 78) may be increased, while maintaining the post-combustion treatment capability of the diffuser nozzle 54 with respect to the exhaust gas stream 68. The diffuser nozzle 54 may, therefore, provide a form factor which can more readily be incorporated into gas turbine engines such as the gas turbine engine 20 and, for example, be retained within a nacelle for the respective gas turbine engine.

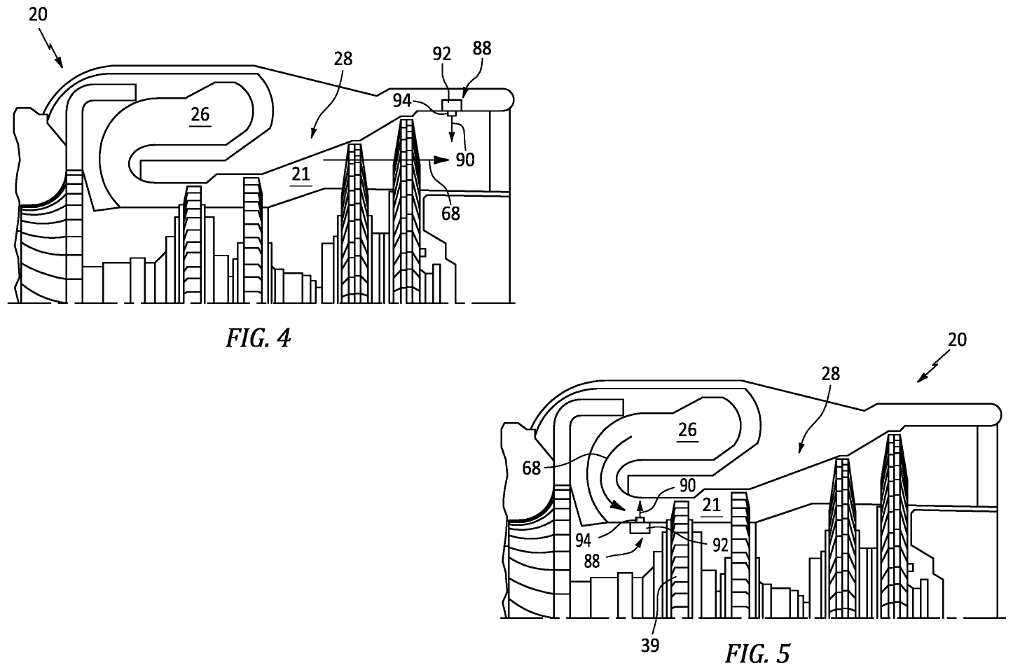

Referring to FIGS. 1, 4, and 5, the present disclosure gas turbine engine 20 further includes a reducing agent injection system 88 configured to inject a reducing agent (schematically illustrated in FIGS. 4 and 5 as reducing agent 90) into the core flow path 21 of the gas turbine engine 20. The post-combustion introduction of a reducing agent into the core flow path 21 may further reduce exhaust emissions of NOₓ, which may be found in the exhaust gas stream 68. Reduction of NOₓ, emissions may be accomplished through one or both of selective catalytic reduction (SCR) and/or selective non-catalytic reduction (SNCR) chemical reactions, as will be discussed in greater detail. The reducing agent may typically be an ammonia-based fluid including, for example, anhydrous ammonia (NH₃) or aqueous ammonia (NH₄OH), however, the present disclosure is not limited to any particular reducing agent.

In some embodiments, the reducing agent injection system 88 may be configured to implement an SCR process to treat NOₓ, found within the exhaust gas stream 68 along the core flow path 21. As shown in FIG. 4, the reducing agent injection system 88 may be positioned within the gas turbine engine 20 to inject the reducing agent 90 into the core flow path 21 downstream of the turbine section 28 (e.g., downstream of a final turbine stage) for mixing with the exhaust gas stream 68. For SCR, the NOₓ, reduction reaction takes place as the mixed exhaust gas stream 68 and the reducing agent 90 pass through the monolithic catalyst structure 82 of the diffuser nozzle 54. The chemical reactions for the SCR process may be generalized by the following equations [1], [2], [3] which convert the NOₓ, constituents, nitric oxide (NO) and nitrogen dioxide (NO₂), to nitrogen (N₂) and water (H₂O):

4NO+4NH₃+O₂→4N₂+6H₂O [1]

NO+NO₂+2NH₃→2N₂+3H₂O [2]

6NO₂+8NH₃→7N₂+12H₂O [3]

The SCR process uses the catalyst of the monolithic catalyst structure 82 to reduce the necessary activation energy for the above-noted SCR reduction reactions. Accordingly, the SCR process can eliminate as much as 95 percent of NOₓ, within the exhaust gas stream 68, with a sufficiently large and appropriately sized monolithic catalyst structure 82.

In some embodiments, the reducing agent injection system 88 may be configured to implement a SCR process and a SNCR process to treat NOₓ found within the exhaust gas stream 68 along the core flow path 21. As shown in FIG. 5, the reducing agent injection system 88 may be positioned within the gas turbine engine 20 to inject the reducing agent 90 into the core flow path 21 downstream of the combustor 26 but upstream of the turbine section 28 (e.g., upstream of the high-pressure turbine 39), for mixing with the exhaust gas stream 68. The SNCR process does not require a catalyst, but may only occur at elevated temperatures such as, for example, between 1,400° F. and 2,000° F. and, preferably, greater than approximately 1,600° F. Accordingly, the SNCR process may only occur in portions of the core flow path 21 of the gas turbine engine 20 with sufficiently high temperatures. The chemical reaction for the SNCR process may be represented by the following equation [4] which converts the NOₓ, constituent, nitric oxide (NO), to nitrogen (N₂) and water (H₂O):

4NO+4NH₃+O₂+4N₂+6H₂O [4]

Because of the very short time that the mixed exhaust gas stream 68 and reducing agent 90 may spend in the temperature range necessary for the SNCR process to occur, the SNCR process may result in a NOₓ, reduction of less than 10 percent in aircraft gas turbine engine applications. Accordingly, the possible increased cost and complexity of positioning the reducing agent injection system 88 upstream of the high-pressure turbine 39 (in contrast to placement of the reducing agent injection system 88 downstream of the turbine section 28) may be considered with the expected NOₓ, reduction provided by the associated SNCR process, for the particular NOₓ, emissions reduction application.

In some embodiments, the reducing agent injection system 88 may include an annular manifold 92, as shown in FIGS. 4 and 5, which extends about the axial centerline 36 of the gas turbine engine 20. The reducing agent injection system 88 may further include a plurality of nozzles 94 circumferentially spaced about the manifold 92 and configured to direct the reducing agent 90 into the exhaust gas stream 68 transiting the core flow path 21. It should be understood, however, that the present disclosure reducing agent injection system 88 is not limited to the above-described configuration and other means for introducing the reducing agent to the exhaust gas stream 68 may be considered.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. It is further noted that various method or process steps for embodiments of the present disclosure are described in the following description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Accordingly, the present disclosure is not to be restricted except in light of the attached claims and their equivalents.

1. A gas turbine engine for an aircraft, the gas turbine engine comprising:
a turbine section;
a fixed structure surrounding at least a portion of the turbine section; and
an exhaust section including a diffuser nozzle and a monolithic catalyst structure,
the diffuser nozzle is mounted to the fixed structure downstream of the turbine section and configured to receive an exhaust gas stream from the turbine section, the diffuser nozzle includes a nozzle inlet, a nozzle outlet, and a housing, the housing is disposed about a nozzle axis of the diffuser nozzle, the housing forms a nozzle duct of the diffuser nozzle, the nozzle duct extends from the nozzle inlet to the nozzle outlet along the nozzle axis, the housing includes a first housing portion, a second housing portion, and a third housing portion, the first housing portion has a first diameter, the first diameter is greater than a second diameter of the nozzle inlet and a third diameter of the nozzle outlet, the second housing portion diverges from the second diameter of the nozzle inlet to the first diameter of the first housing portion, the third housing portion converges from the first diameter of the first housing portion to the third diameter of the nozzle outlet, and
the monolithic catalyst structure is disposed within the first housing portion.

2. (canceled)

3. The gas turbine engine of claim 1, wherein the gas turbine engine is a turboprop.

4. The gas turbine engine of claim 1, wherein the monolithic catalyst structure comprises a plurality of cells defining a respective plurality of channels extending therethrough.

5. The gas turbine engine of claim 4, wherein the plurality of cells includes a catalytic washcoat.

6. The gas turbine engine of claim 1, wherein the turbine section comprises a reducing agent injection system configured to inject a reducing agent into a core flow path of the gas turbine engine.

7. The gas turbine engine of claim 6, further comprising a combustor including a combustor outlet, wherein:
the turbine section is disposed downstream of the combustor outlet;
the reducing agent injection system includes a plurality of nozzles disposed at the combustor outlet, the plurality of nozzles configured to inject the reducing agent into the core flow path of the gas turbine engine upstream of the turbine section.

8. The gas turbine engine of claim 6, wherein the reducing agent injection system is located downstream of the turbine section.

9. The gas turbine engine of claim 6, wherein the reducing agent is an ammonia-based reducing agent.

10. The gas turbine engine of claim 2, further comprising a nacelle defining an exterior housing of the gas turbine engine, wherein the diffuser nozzle is located entirely within the nacelle.

11. (canceled)

12. A method for treating exhaust gases from a gas turbine engine for an aircraft, the method comprising:
directing an exhaust gas stream from a turbine section of the gas turbine engine into an exhaust section of the gas turbine engine; and
directing the exhaust gas stream through a monolithic catalyst structure of the exhaust section to remove nitrogen oxides (NOₓ) from the exhaust gas stream by reducing a velocity of the exhaust gas stream before directing the exhaust gas stream through the monolithic catalyst structure and increasing the velocity of the exhaust gas stream after directing the exhaust gas stream through the monolithic catalyst structure.

13. The method of claim 12, wherein the exhaust section further includes a diffuser nozzle configured to receive the exhaust gas stream from the turbine section, the monolithic catalyst structure located within the diffuser nozzle.

14. The method of claim 12, wherein the monolithic catalyst structure comprises a plurality of cells defining a respective plurality of channels extending therethrough.

15. The method of claim 12, further comprising injecting a reducing agent into a core flow path of the gas turbine engine.

16. The method of claim 15, wherein the step of injecting the reducing agent into the core flow path of the gas turbine engine includes injecting the reducing agent into the core flow path upstream of the turbine section.

17. The method of claim 15, wherein the step of injecting the reducing agent into the core flow path of the gas turbine engine includes injecting the reducing agent into the core flow path downstream of the turbine section.

18. The method of claim 15, wherein the step of injecting the reducing agent into the core flow path of the gas turbine engine includes injecting an ammonia-based reducing agent into the core flow path of the gas turbine engine.

19. The method of claim 13, wherein the diffuser nozzle is entirely located within a nacelle defining an exterior housing of the gas turbine engine.

20. The method of claim 13, further comprising diffusing the exhaust gas stream with the diffuser nozzle at a first axial location within the diffuser nozzle and subsequently concentrating the exhaust gas stream with the diffuser nozzle at a second axial location within the diffuser nozzle which is different than the first axial location.

21. A gas turbine engine for an aircraft, the gas turbine engine comprising:
a turbine section including a turbine at an axially downstream end of the turbine section;
a casing surrounding the turbine, the casing including a distal end positioned axially downstream of the turbine;
a reducing agent injection system including a plurality of nozzles disposed on the casing at the axially downstream end, the plurality of nozzles configured to inject a reducing agent into the core flow path of the gas turbine engine downstream of the turbine; and
an exhaust section including a diffuser nozzle and a monolithic catalyst structure, the diffuser nozzle mounted to the casing at the distal end, the monolithic catalyst structure disposed within the diffuser nozzle, the diffuser nozzle configured to receive an exhaust gas stream from the turbine section and direct the exhaust gas stream through the monolithic catalyst structure.
